(19) United States
(12) Patent Application Publication
(10) Pub. No.: US 2026/0086253 A1
(43) Pub. Date: Mar. 26, 2026

(54) PHANTOM, CALIBRATION APPARATUS, CALIBRATION METHOD, AND CALIBRATION PROGRAM

(71) Applicant: FUJIFILM Corporation, Tokyo (JP)

(72) Inventors: Shinichi KOJIMA, Kanagawa (JP); Kazuma YOKOI, Kanagawa (JP); Isao TAKAHASHI, Kanagawa (JP)

(73) Assignee: FUJIFILM Corporation, Tokyo (JP)

(21) Appl. No.: 19/334,758

(22) Filed: Sep. 19, 2025

(30) Foreign Application Priority Data
Sep. 24, 2024 (JP) 2024-165276

(51) Int. Cl. G01T 7/00

(52) U.S. Cl. CPC G01T 7/005

(57) ABSTRACT

A phantom is provided for acquiring calibration data of a detector that outputs an electric signal corresponding to a photon energy of incident radiation. The phantom includes a first base substance and at least one second base substance having an attenuation coefficient higher than an attenuation coefficient of the first base substance. The first base substance has a thickness that changes in a direction orthogonal to an irradiation field of radiation during imaging. The second base substance is embedded in the first base substance, and the size and the position of the second base substance change in a direction orthogonal to an irradiation field of the radiation during the imaging.

### CROSS REFERENCE TO RELATED APPLICATIONS

The present application claims priority from Japanese Patent Application No. 2024-165276, filed on Sep. 24, 2024, the entire disclosure of which is incorporated herein by reference.

### BACKGROUND

### Technical Field

The present disclosure relates to a phantom, a calibration apparatus, a calibration method, and a calibration program.

### Related Art

A photon-counting computed tomography (PCCT) apparatus comprising a photon-counting detector that is a detector adopting a photon-counting method is known. Since the photon-counting detector can measure a photon energy, which is an energy of an incident radiation photon, the PCCT apparatus can obtain a medical image in which substances having different compositions are discriminated, for example, a medical image in which an iodine contrast medium used in angiography and calcified plaque in a blood vessel are discriminated.

In addition, the dual-energy (DE) CT apparatus acquires the energy information of the X-rays in the same manner as the PCCT apparatus. Then, in the DECT apparatus, it is possible to generate a virtual monochromatic X-ray image that looks like an image captured by X-rays at any single energy level by reconstructing two pieces of projection data captured at two types of tube voltages at any single energy level.

By the way, in a case in which imaging is performed by a PCCT apparatus and a DECT apparatus (hereinafter, represented by a PCCT apparatus), the same substance should have the same value in the acquired image regardless of the position and the size thereof. However, in the PCCT apparatus, the attenuation coefficient may be different even for the same substance depending on the size of the subject and the position of the substance, or may be different values in images (substance discrimination image and virtual monochromatic image) using energy.

Therefore, in order to obtain a substance discrimination image or the like in the PCCT apparatus, the detector is calibrated. Therefore, for combinations of a plurality of base substances, which are substances having known compositions and thicknesses, a relationship between an output measured by the photon-counting detector and a photon energy is acquired in advance as calibration data for each detector element.

For example, JP2022-520241A proposes a method of acquiring calibration data using a phantom in which objects having a cylindrical shape, a rectangular parallelepiped shape, and a prism shape are combined. In addition, JP2022-520241A also proposes a phantom that changes in size in a direction orthogonal to a movement direction in a case where the phantom is installed in a PCCT apparatus and imaging is performed.

For the calibration data, data of various sizes at various positions in the subject is desired particularly for a substance whose value is desired to be matched. However, in a case in which the calibration data is acquired, it takes time and effort to perform a plurality of times of imaging while changing the position of the substance in the phantom.

### SUMMARY OF THE INVENTION

The present disclosure has been made in view of the above circumstances, and an object of the present disclosure is to enable simple acquisition of a plurality of types of desired calibration data.

According to the present disclosure, there is provided a phantom for acquiring calibration data of a detector that outputs an electric signal corresponding to a photon energy of incident radiation, the phantom comprising:
a first base substance; and
at least one second base substance having an attenuation coefficient larger than an attenuation coefficient of the first base substance,
in which the first base substance has a thickness that changes in a direction orthogonal to an irradiation field of the radiation during imaging, and
the second base substance is embedded in the first base substance and has a size and a position that change in the direction orthogonal to the irradiation field of the radiation during imaging.

In the phantom according to the present disclosure, the first base substance has an occupancy ratio lager than an occupancy ratio of the second base substance.

In the phantom according to the present disclosure, the first base substance has a truncated cone shape having a central axis in the direction orthogonal to the irradiation field of the radiation during imaging.

According to the present disclosure, there is provided a calibration apparatus that acquires calibration data of a detector which outputs an electric signal corresponding to a photon energy of incident radiation, the calibration apparatus comprising:
a processor,
wherein the processor is configured to acquire the calibration data of the detector using the phantom according to the present disclosure.

According to the present disclosure, there is provided a calibration method in which a computer acquires calibration data of a detector that outputs an electric signal corresponding to a photon energy of incident radiation, the calibration method comprising:
acquiring the calibration data of the detector using the phantom according to the present disclosure.

According to the present disclosure, there is provided a calibration program causing a computer to execute a procedure of acquiring calibration data of a detector that outputs an electric signal corresponding to a photon energy of incident radiation, the calibration program causing the computer to execute:
a procedure of acquiring the calibration data of the detector using the phantom according to the present disclosure.

The technology of the present disclosure may be applied to a program product.

According to the present disclosure, it is possible to easily acquire a plurality of types of desired calibration data.

### BRIEF DESCRIPTION OF THE DRAWINGS

FIG. 1 is a front view and a side view showing a phantom according to an embodiment of the present disclosure.

FIG. 2 is a perspective view showing a first base substance.

FIG. 3 is a perspective view showing a second base substance.

FIG. 4 is a schematic configuration diagram of the medical image capturing system comprising the calibration apparatus according to the present embodiment.

FIG. 5 is a diagram showing a hardware configuration of the calibration apparatus according to the present embodiment.

FIG. 6 is a functional configuration diagram of the calibration apparatus according to the present embodiment.

FIG. 7 is a diagram for describing a calibration method.

FIG. 8 is a flowchart showing processing performed in the present embodiment.

### DETAILED DESCRIPTION

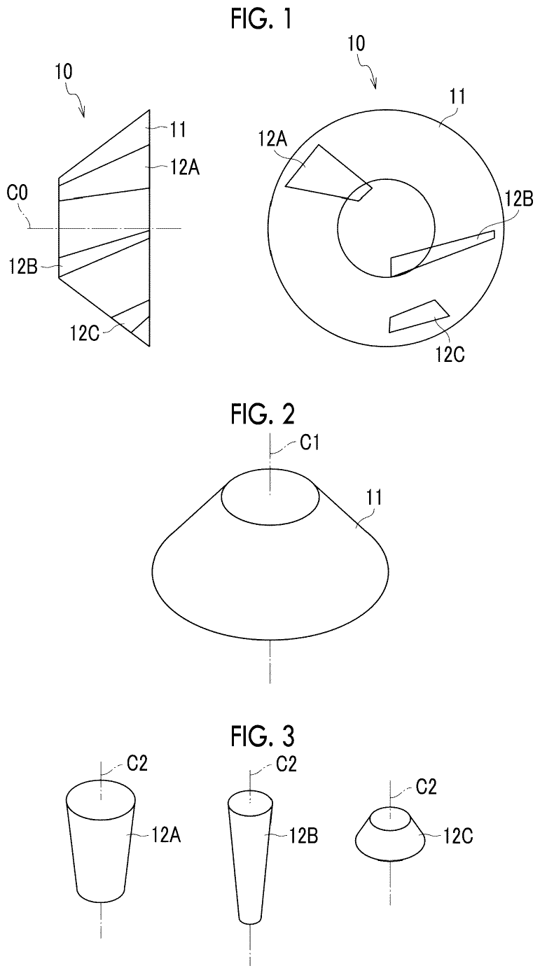

Hereinafter, embodiments of the present disclosure will be described with reference to the drawings. First, a phantom according to an embodiment of the present disclosure will be described. FIG. 1 is a front view and a side view showing a configuration of a phantom according to the present embodiment. As shown in FIG. 1, a phantom 10 according to the present embodiment has a truncated cone shape. The truncated cone is a cone with a circular bottom surface. That is, the truncated cone is a three-dimensional figure obtained by cutting the cone with a plane parallel to the bottom surface and removing a portion of the small cone. The phantom 10 includes the first base substance 11 and at least one second base substance 12. The phantom 10 is imaged in a CT apparatus described below and is used to acquire calibration data of the detector.

FIG. 2 is a diagram showing a first base substance. The first base substance 11 consists of, for example, a material having a radiation attenuation coefficient similar to that of a human body. Examples of such a material include acrylic. The first base substance 11 has a truncated cone shape, and a plurality of second base substances 12 described below are embedded therein. The first base substance 11 has an occupancy ratio lager than an occupancy ratio of the second base substance 12 so that the phantom 10 is modeled after the human body. In the side view of FIG. 1, a straight line connecting the center points of the left side surface and the right side surface of the truncated cone (that is, the center points of the upper and lower surfaces of the circular shape) is shown as the central axis C1 of the first base substance 11. The central axis C1 of the first base substance 11 coincides with the central axis C0 (see FIG. 1) of the phantom 10.

In a case in which the CT apparatus is calibrated as described below using the phantom 10 according to the present embodiment, the central axis C1 of the first base substance 11 is installed in the CT apparatus so as to be orthogonal to the irradiation field of the radiation. Therefore, the first base substance 11 has a thickness that changes in a direction orthogonal to an irradiation field of the radiation during imaging. In the present embodiment, the direction orthogonal to the irradiation field is a direction orthogonal to the optical axis of the radiation and coincides with a direction in which an imaging table moves in the CT apparatus described below. The first base substance 11 is created such that a maximum diameter thereof is within a maximum irradiation field of the radiation that can be set by the CT apparatus 2 described below.

FIG. 3 is a diagram showing a second base substance. The second base substance 12 consists of a material having an attenuation coefficient larger than an attenuation coefficient of acrylic, which is the material of the first base substance 11. Examples of such a material include aluminum, but other materials having the same attenuation coefficient as a contrast agent actually used, such as iodine, can be used. The second base substance 12 has, for example, a truncated cone shape, and has a size of a cross section orthogonal to a central axis C2 that changes in a direction along the central axis C2 connecting the center points of the upper and lower surfaces of the circular shape. In the present embodiment, three types of second base substances 12A, 12B, and 12C having different ways of changing the length and the size of the cross section orthogonal to the central axis C2 are used. In addition, the end face of the second base substance 12 is processed to coincide with the surface of the first base substance 11 in a case of being embedded in the first base substance 11, but in FIG. 3, the second base substances 12A to 12C are shown in a truncated cone shape for description.

The second base substances 12A to 12C are embedded in the first base substance 11 such that the central axes C2 thereof are inclined with respect to the central axis C1 of the first base substance 11. As a result, in the phantom 10, the sizes and positions of the second base substances 12A to 12C are changed in a direction orthogonal to the irradiation field of the radiation during the imaging.

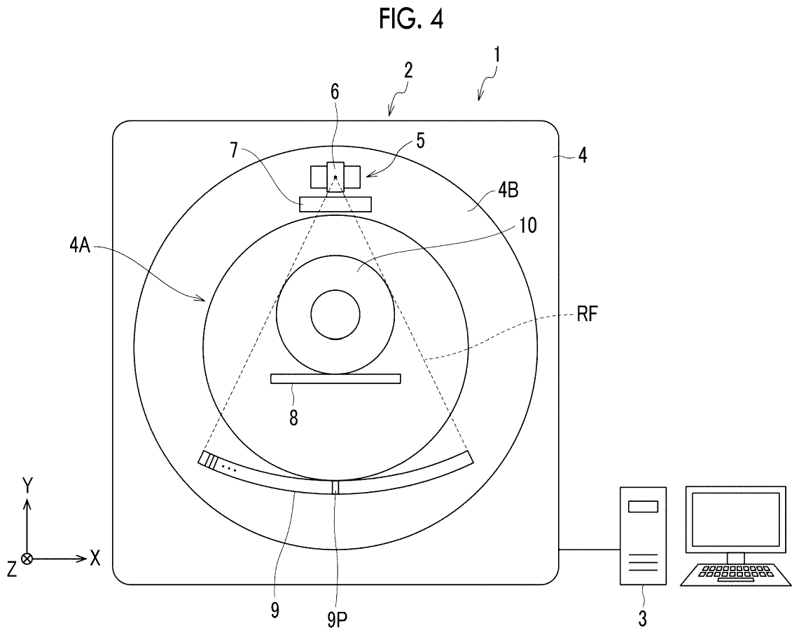

Next, a calibration apparatus according to the embodiment of the present disclosure will be described. FIG. 4 is a schematic configuration diagram of a medical image capturing system comprising the calibration apparatus according to the present embodiment. As shown in FIG. 4, a medical image capturing system 1 according to the present embodiment comprises a CT apparatus 2 and a console 3.

The CT apparatus 2 comprises a gantry 4 and an examination table 8. It should be noted that, in the following description, a lateral direction in FIG. 4 is an X axis, a longitudinal direction is a Y axis, and a direction orthogonal to an XY plane is a Z axis.

The gantry 4 has an opening portion 4A, and a subject as an imaging target is disposed in the opening portion 4A in a state of being placed on the examination table 8. In addition, the phantom 10 according to the present embodiment is disposed in the opening portion 4A in a state of being placed on the examination table 8 during calibration. The gantry 4 and the examination table 8 can be moved relatively in the Z axis direction. The phantom 10 is placed on the examination table 8 such that the central axis C1 of the first base substance 11 coincides with the Z-axis.

A radiation source 5 having a radiation tube 6 and a bowtie filter 7 and a detector 9 are disposed inside the gantry 4 to face each other with the examination table 8 interposed therebetween. The bowtie filter 7 increases a dose near the center and decreases a dose in the periphery to optimize the amount of exposure in order to suppress an amount of exposure to the subject in a peripheral portion. The radiation emitted from the radiation tube 6 is molded into a beam shape suitable for the size of the subject or the phantom 10 according to the present embodiment by the bowtie filter 7 and is emitted to the subject or the phantom 10.

The detector 9 detects the radiation transmitted through the subject or the phantom 10 placed on the examination table 8, and generates projection data according to the dose of the detected radiation. As an example, the detector 9 according to the present embodiment is a photon-counting detector in which a plurality of detection elements 9P that detect the photon energy, which is energy of a photon of the incident radiation, are arranged in an arc shape centered on a focal point of the radiation tube 6.

In the present embodiment, X-rays are used as an example of the radiation, but the present invention is not limited thereto, and γ-rays or the like can also be used.

The radiation source 5 and the detector 9 are attached to a rotating plate 4B in the gantry 4 and are rotated around the examination table 8 by a rotational drive unit (not shown). In a case of imaging the subject, the radiation irradiation from the radiation source 5 and the detection of the radiation by the detector 9 are repeated with both rotations, and a raw data is acquired in a plurality of view units in which the projection angles of the radiation to the subject are different. The raw data acquired by the detector 9 is output to the console 3.

The console 3 sets the dose of the radiation emitted from the radiation tube 6, the rotation speed of the gantry 4, the relative movement speed between the gantry 4 and the examination table 8, and the like based on imaging conditions input by an operator, such as a technician.

The console 3 according to the present embodiment performs acquisition of calibration data using the phantom 10 according to the present embodiment, control related to imaging of the subject, generation of a tomographic image from data acquired by imaging, setting of data storage, and the like. The console 3 is an example of a calibration apparatus according to the present disclosure.

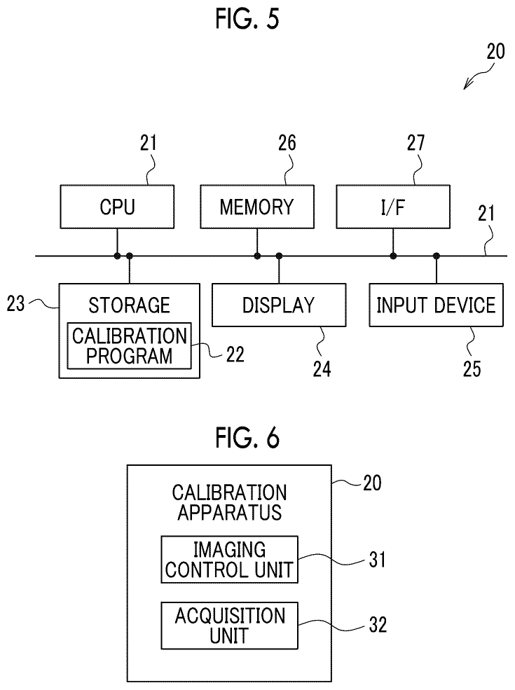

Hereinafter, the calibration apparatus according to the present embodiment will be described. First, a hardware configuration of the calibration apparatus according to the present embodiment included in the console 3 will be described with reference to FIG. 5. As shown in FIG. 5, the calibration apparatus 20 included in the console 3 is a computer such as a workstation, a server computer, and a personal computer, and comprises a central processing unit (CPU) 21, a non-volatile storage 23, and a memory 26 as a transitory storage area.

Further, the calibration apparatus 20 comprises a display 24, an input device 25, and an interface (I/F) 27. The CPU 21, the storage 23, the display 24, the input device 25, the memory 26, and the I/F 27 are connected to a bus 28. The CPU 21 is an example of a processor according to the present disclosure.

The storage 23 is realized by a hard disk drive (HDD), a solid-state drive (SSD), a flash memory, and the like. A calibration program 22, which is installed in the calibration apparatus 20, is stored in the storage 23 as a storage medium. The CPU 21 reads out the calibration program 22 from the storage 23, loads the calibration program 22 in the memory 26, and executes the loaded calibration program 22.

The display 24 is a device that displays various screens and is, for example, a liquid crystal display or an electro luminescence (EL) display.

The input device 25 is used by the operator to input an instruction and various types of information related to an imaging condition in a case of imaging the subject, image generation, display, and the like. Examples of the input device 25 include various switches, a button, a touch panel, a touch pen, a keyboard, and a mouse. It should be noted that the display 24 and the input device 25 may be integrated into a touch panel display.

The I/F 27 communicates various types of information between the gantry 4, the rotational drive unit (not shown), the radiation source 5, and the detector 9 by wired communication or wireless communication.

The calibration program 22 is stored in a storage device of the server computer connected to the network or in a network storage to be accessible from the outside, and is, in response to a request, downloaded and installed in the computer constituting the calibration apparatus 20. Alternatively, the calibration program 22 is distributed in a state of being recorded on a recording medium, such as a digital versatile disc (DVD) or a compact disc read only memory (CD-ROM), and is installed in the computer constituting the calibration apparatus 20 from the recording medium.

Hereinafter, a functional configuration of the calibration apparatus according to the present embodiment will be described. FIG. 6 is a diagram showing the functional configuration of the calibration apparatus according to the present embodiment. As shown in FIG. 6, the calibration apparatus 20 comprises an imaging control unit 31 and an acquisition unit 32. Then, the CPU 21 functions as the imaging control unit 31 and the acquisition unit 32 by executing the calibration program 22.

The calibration apparatus 20 of the present embodiment is a device for calibrating the entire medical image capturing system 1, mainly the detector 9. In the medical image capturing system 1 comprising the detector 9, which is a photon-counting detector, a photon energy spectrum related to the projection data of the subject can be acquired. Therefore, a medical image in which substances having different compositions are discriminated or a medical image divided into a plurality of energy components can be generated. In order to obtain the medical image in which substances having different compositions are discriminated as described above, and the like, it is necessary to calibrate in advance a relationship between an output when a combination of a plurality of base substances, which are substances having known compositions and thicknesses, is measured by the detector 9 and the photon energy, for each of the detection elements 9P. The calibration apparatus 20 is a device used for the calibration.

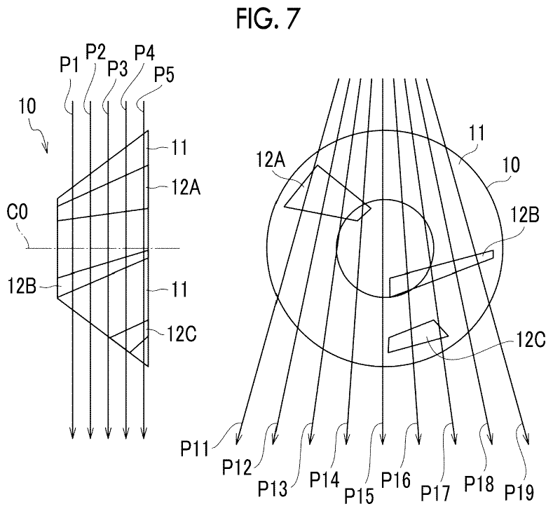

In the present embodiment, the calibration apparatus 20 uses the phantom 10 according to the present embodiment for calibration of the detector 9. In FIG. 4, the phantom 10 is positioned in the irradiation field RF of the radiation, and the phantom 10 is fixed to the examination table 8 by a fixture (not shown) such that a central axis C0 of the phantom 10 coincides with the Z-axis. Hereinafter, an example of a calibration method of the detector 9, which is a photon-counting detector, will be described. FIG. 7 is a diagram for describing a calibration method.

In the present embodiment, the phantom 10 fixed to the examination table 8 is imaged while being moved in the Z-axis direction without rotating the radiation source 5 and the detector 9, and the calibration data is acquired. Alternatively, the calibration data is acquired while the movement, the stop, and the imaging in the Z-axis direction are repeated. In the present embodiment, it is assumed that the calibration data is acquired while the phantom 10 is repeatedly moved, stopped, and imaged in the Z-axis direction.

The first base substance 11 constituting the phantom 10 according to the present embodiment has a thickness that changes in a direction orthogonal to an irradiation field of radiation during imaging. The second base substances 12A to 12C are embedded in the first base substance 11, and the sizes and positions thereof change in a direction orthogonal to an irradiation field of radiation during imaging. Therefore, in a case in which the phantom 10 fixed to the examination table 8 is moved in the Z-axis direction, the transmission path of the radiation in the phantom 10 changes at each of the moved positions. For example, as shown in the side view of FIG. 7, in a case in which the phantom 10 is moved in the Z-axis direction, the transmission path of the radiation in the phantom 10 is changed as shown in, for example, P1 to P5, and as a result, the length of the transmission path is also changed. In each of the transmission paths P1 to P5, the distance of the second base substances 12A to 12C from the central axis C0 and the length of the transmission path are also changed.

Further, at one movement position of the phantom 10, as shown in the front view of FIG. 7, the radiation transmits through the phantom 10 in a fan shape. For example, in a case in which the transmission paths of the radiation are discretely set at nine positions P11 to P19 as shown in the front view of FIG. 7, the lengths of the transmission paths of the radiation in the phantom 10 are different from each other in the transmission paths P11 to P19, and the distances from the central axes C0 of the second base substances 12A to 12C and the lengths of the transmission paths are also different.

In the present embodiment, in a plurality of transmission paths at each movement position of the examination table 8, the transmission path length of the radiation in the phantom 10 and the transmission path lengths of the radiation in the second base substances 12A to 12C are measured, and the transmission path length of the radiation in the first base substance 11 is derived by subtracting the transmission path lengths of the second base substances 12A to 12C from the transmission path length of the phantom 10. The transmission path length of the radiation in the first base substance 11 is the thickness of the first base substance 11 in the transmission path of the radiation, and the transmission path lengths of the radiation in the second base substances 12A to 12C are the thicknesses of the second base substances 12A to 12C in the transmission path of the radiation.

Therefore, in the present embodiment, the phantom 10 fixed to the examination table 8 is inserted into the irradiation field RF of the radiation, the imaging control unit 31 of the calibration apparatus 20 moves the examination table 8, the radiation is emitted from the radiation source 5 at each movement position, and the detector 9 detects the radiation transmitted through each transmission path of the phantom 10, so that the acquisition unit 32 acquires the photon energy spectrum in each transmission path at each movement position as the calibration data K0. For example, in a case in which the number of types of movement positions of the phantom 10 in the Z direction is n and the number of types of transmission paths at the respective movement positions is m, the calibration data K0 for the thicknesses of n×m types of the first base substance 11 and the second base substances 12A to 12C is acquired.

The n×m types of calibration data K0 acquired in this way are output to the console 3, are stored in the storage 23 of the console 3, and are used for calibration of the projection data of the subject.

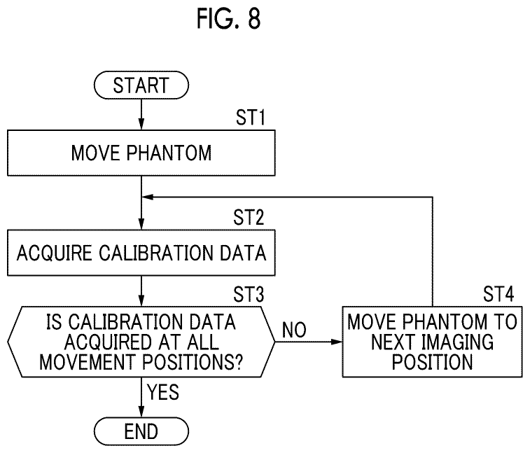

Next, processing performed in the present embodiment will be described. FIG. 8 is a flowchart showing a process performed in the present embodiment. It should be noted that the phantom 10 is assumed to be fixed to the examination table 8. First, the imaging control unit 31 moves the examination table 8 to move the phantom 10 in the Z-axis direction of the CT apparatus 2 (step ST1), and the acquisition unit 32 acquires the calibration data on a plurality of transmission paths of the radiation at the movement position of the phantom 10 (step ST2). Then, the imaging control unit 31 determines whether or not the calibration data is acquired at all the movement positions (step ST3). In a case in which the determination result in step ST3 is “No”, the phantom 10 is moved to the next imaging position (step ST4), and the processing returns to step ST2. In a case in which YES is determined in step ST3, the processing ends.

As described above, the phantom 10 according to the present embodiment includes the first base substance 11 and at least one second base substance 12A to 12C having an attenuation coefficient larger than the attenuation coefficient of the first base substance 11, the first base substance 11 changes in thickness in a direction orthogonal to an irradiation field of the radiation during imaging, and the second base substance 12A to 12C are embedded in the first base substance 11 and change in size and position in a direction orthogonal to the irradiation field of the radiation during imaging. Therefore, it is possible to acquire the calibration data K0 for the first base substances 11 having different thicknesses and the second base substances 12A to 12C having different thicknesses and different positions by using only one phantom 10. Therefore, in a case of acquiring the calibration data K0, it is not necessary to perform the imaging a plurality of times while changing the size and position of the substance in the phantom, and as a result, it is possible to easily acquire a plurality of types of desired calibration data K0.

In the above-described embodiment, three types of second base substances 12A to 12C are used, but the present invention is not limited thereto. One kind, two kinds, or four or more kinds of the second base substances 12 may be used. In addition, in a case where a plurality of second base substances 12 are used, the second base substance 12 may be composed of materials having different attenuation coefficients. For example, in addition to iodine, the second base substance 12 may be constituted of a material having an attenuation coefficient, such as gold, which is used as a contrast agent.

In addition, in the above-described embodiment, the phantom 10 and the calibration apparatus 20 according to the present embodiment are applied to the acquisition of the calibration data in the CT apparatus 2 comprising the photon counting type detector 9, but the present disclosure is not limited thereto. The phantom 10 and the calibration apparatus 20 according to the present embodiment can also be applied to the acquisition of the calibration data in the DECT apparatus.

In addition, in the above-described embodiment, the first base substance 11 has a truncated cone shape, but the present invention is not limited thereto. As long as the shape is a shape in which the thickness changes in a direction orthogonal to the irradiation field of the radiation during imaging, any shape other than the truncated cone shape can be used. In addition, the shapes of the second base substances 12A to 12C can also be any shape other than the truncated cone shape.

In the present embodiment, each processing of the calibration apparatus 20 is executed by any computer. In addition, any computer may execute these processes by a processor as hardware, a program as software, or a combination thereof. In that case, the processor is configured to execute various types of processing in the calibration apparatus 20 according to the present embodiment in cooperation with the program, and can function as each unit or each means in the present embodiment. In addition, the execution order of the processing by the processor is not limited to the order described above and may be appropriately changed. Any computer may be a general-purpose computer, a computer for a specific use, a workstation, or another system capable of executing each process.

The processor may be configured by one or a plurality of hardware, and the type of hardware is not limited. For example, the processor may be configured by hardware such as a central processing unit (CPU), a micro processing unit (MPU), a programmable logic device such as a field programmable gate array (FPGA), a dedicated circuit for executing specific processing such as an application specific integrated circuit (ASIC), a graphic processing unit (GPU), or a neural processing unit (NPU). In addition, the types of hardware may be a combination of different types of hardware. In a case where a plurality of hardware are configured to execute one or a plurality of processes of a certain processor, the plurality of hardware may be present in devices physically separated from each other, or may be present in the same device. In addition, in any of the embodiments, the order of each processing by the processor is not limited to the above order, and may be appropriately changed. The hardware is configured by an electric circuit (circuitry) or the like in which circuit elements such as semiconductor elements are combined.

Further, the program may be software such as firmware or a microcode. In addition, the program may be, for example, a program module group, and each function thereof may be realized by a processor configured to execute each function. The program may be a program code or a plurality of code segments stored in one or a plurality of non-transitory computer-readable media (for example, a storage medium or other storage). The program may be divided and stored in a plurality of non-transitory computer-readable media present in devices physically separated from each other. The program code or code segment may represent any combination of a procedure, a function, a subprogram, a routine, a subroutine, a module, a software package, a class, or an instruction, a data structure, or a program statement. The program code or code segment may be connected to another code segment or a hardware circuit by transmitting and receiving information, data, an argument, a parameter, or a content of a memory.

In addition, in the above-described embodiment, the calibration program 22 has been described as being stored (installed) in the storage 23 in advance, but the present disclosure is not limited to this. The calibration program 22 may be provided in a form of being recorded on a recording medium, such as a compact disc read only memory (CD-ROM), a digital versatile disc read only memory (DVD-ROM), and a universal serial bus (USB) memory. Further, the calibration program 22 may be downloaded from an external apparatus through the network.

The technology of the present disclosure extends to all program products. The program product includes products in all aspects for providing a program. For example, the program product includes a program provided through a network such as the Internet, and a non-transitory computer-readable recording medium such as a CD-ROM, a DVD, and a USB memory in which the program is stored.

Hereinafter, the supplementary notes of the present disclosure will be described.

### Supplementary Note 1

A phantom for acquiring calibration data of a detector that outputs an electric signal corresponding to a photon energy of incident radiation, the phantom comprising:
a first base substance; and
at least one second base substance having an attenuation coefficient larger than an attenuation coefficient of the first base substance,
in which the first base substance has a thickness that changes in a direction orthogonal to an irradiation field of the radiation during imaging, and
the second base substance is embedded in the first base substance and has a size and a position that change in the direction orthogonal to the irradiation field of the radiation during imaging.

### Supplementary Note 2

The phantom according to Supplementary Note 1, in which the first base substance has an occupancy ratio larger than an occupancy ratio of the second base substance.

### Supplementary Note 3

The phantom according to Supplementary Note 1 or 2, in which the first base substance has a truncated cone shape having a central axis in the direction orthogonal to the irradiation field of the radiation during imaging.

### Supplementary Note 4

A calibration apparatus that acquires calibration data of a detector which outputs an electric signal corresponding to a photon energy of incident radiation, the calibration apparatus comprising:
a processor,
in which the processor is configured to acquire the calibration data of the detector using the phantom according to any one of Supplementary Notes 1 to 3.

### Supplementary Note 5

A calibration method in which a computer acquires calibration data of a detector that outputs an electric signal corresponding to a photon energy of incident radiation, the calibration method comprising:
acquiring the calibration data of the detector using the phantom according to any one of Supplementary Notes 1 to 3.

### Supplementary Note 6

A calibration program causing a computer to execute a procedure of acquiring calibration data of a detector that outputs an electric signal corresponding to a photon energy of incident radiation, the calibration program causing the computer to execute:
a procedure of acquiring the calibration data of the detector using the phantom according to any one of supplementary notes 1 to 3.

What is claimed is:

1. A phantom for acquiring calibration data of a detector that outputs an electric signal corresponding to a photon energy of incident radiation, the phantom comprising:
a first base substance; and
at least one second base substance having an attenuation coefficient larger than an attenuation coefficient of the first base substance,
wherein the first base substance has a thickness that changes in a direction orthogonal to an irradiation field of the radiation during imaging, and
the second base substance is embedded in the first base substance and has a size and a position that change in the direction orthogonal to the irradiation field of the radiation during imaging.

2. The phantom according to claim 1,
wherein the first base substance has an occupancy ratio larger than an occupancy ratio of the second base substance.

3. The phantom according to claim 1,
wherein the first base substance has a truncated cone shape having a central axis in the direction orthogonal to the irradiation field of the radiation during imaging.

4. A calibration apparatus that acquires calibration data of a detector that outputs an electric signal corresponding to a photon energy of incident radiation, the calibration apparatus comprising:
a processor,
wherein the processor is configured to acquire the calibration data of the detector using the phantom according to claim 1.

5. A calibration method in which a computer acquires calibration data of a detector that outputs an electric signal corresponding to a photon energy of incident radiation, the calibration method comprising:
acquiring the calibration data of the detector using the phantom according to claim 1.

6. A non-transitory computer-readable storage medium that stores a calibration program causing a computer to execute a procedure of acquiring calibration data of a detector that outputs an electric signal corresponding to a photon energy of incident radiation, the calibration program causing the computer to execute:
a procedure of acquiring the calibration data of the detector using the phantom according to claim 1
